(19) United States
(12) Patent Application Publication
(10) Pub. No.: US 2022/0347752 A1
(43) Pub. Date: Nov. 3, 2022

(54) REMOVAL OF MAGNETIC POWDER FROM A PRINT CHAMBER

(71) Applicant: HEWLETT-PACKARD DEVELOPMENT COMPANY, L.P., Spring, TX (US)

(72) Inventors: Rhys MANSELL, Sant Cugat del Valles (ES); Mohammad JOWKAR, Sant Cugat del Valles (ES); Luis GARCIA GARCIA, Sant Cugat del Valles (ES)

(21) Appl. No.: 17/244,816

(22) Filed: Apr. 29, 2021

(51) Int. Cl. B22F 10/73; B22F 10/14; B22F 12/30; B22F 12/53; B22F 1/00; B33Y 10/00; B33Y 30/00; B33Y 40/00; B33Y 70/00; B03C 1/30

(52) U.S. Cl. CPC B22F 10/73; B22F 10/14; B22F 12/30; B22F 12/53; B22F 1/0059; B33Y 10/00; B33Y 30/00; B33Y 40/00; B33Y 70/00; B03C 1/30

(57) ABSTRACT

A printer is described that comprises a print chamber and an electromagnet moveable within the print chamber. The electromagnet has an on state and an off state. The electromagnet is to collect magnetic powder within the print chamber when in the on state, and to deposit magnetic powder when in the off state.

### BACKGROUND

In some examples of 3D printing, metal parts may be formed through the selective solidification of a metallic powder.

### BRIEF DESCRIPTION OF THE DRAWINGS

FIG. 1 shows an example 3D printer;

FIG. 2 shows the example 3D printer, in which a carriage of the 3D printer is in (a) a first position and (b) a second position;

FIG. 3 shows an example method to remove magnetic powder from a print chamber; and

FIG. 4 shows an example method to remove residual magnetic powder with a magnet.

### DETAILED DESCRIPTION

In some examples of 3D printing, parts may be formed through the selective solidification of a magnetic powder. In one example of a 3D printer, a layer of magnetic powder is deposited onto a build platform and spread evenly by a spreader. A carriage, movable within a print chamber of the 3D printer, passes over the build platform, and printheads carried on the underside of the carriage selectively apply a binding agent to the powder. Liquid components in the binding agent may partially evaporate, and the build platform is lowered ready for the next layer of powder. This process is then repeated layer-by-layer until the build is complete. Once complete, the build is heated to complete the evaporation of the liquid components and to cure the binder to achieve a green part. The green part is then removed from the surrounding powder and moved to a sintering furnace in order to burn off the binder and sinter the powder.

During the build process, movement of the spreader and/or the carriage over the build platform may cause some of the magnetic powder to be aerosolized, i.e. thrown up into the print chamber. The aerosolized powder may then settle on surfaces within the print chamber. With repeated printing, a buildup of powder may occur, which may adversely affect or even damage components of the 3D printer.

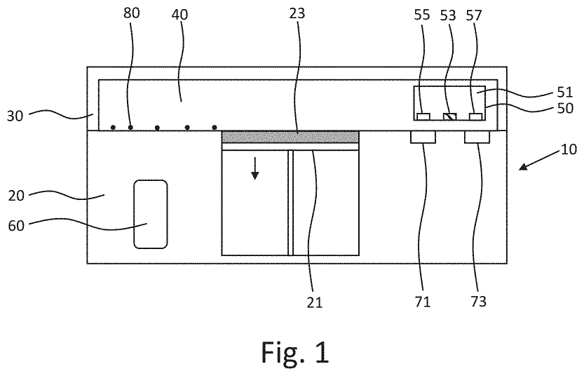

FIG. 1 shows an example 3D printer 10 that comprises a base unit 20 and a hood 30 that define an interior print chamber 40 in which a carriage assembly 50 moves.

The base unit 20 comprises a build platform 21 and a spreader (not shown).

The build platform 21 supports a powder bed 23 formed from successive layers of magnetic powder. During a build process, a layer of magnetic powder is deposited onto the build platform 21. Examples of magnetic powders include various grades of steel and stainless steel, Inconel®, as well as ferromagnetic composites and mixes. Moreover, the powder may comprise a material that is magnetic in powdered form but is not magnetic when sintered, such as 316L stainless steel comprising a small amount of ferrite. The spreader moves over the powder bed 23 to evenly spread the layer of magnetic powder. A binding agent is then selectively applied to the layer of magnetic powder. The build platform 21 then lowers, a further layer of magnetic powder is deposited onto the layer of magnetic powder, and the process repeats.

The carriage assembly 50 comprises a carriage 51, printheads 53, and magnets 55,57. The carriage 51 is driven back and forth within the print chamber 40 by a drive assembly (not shown) under the control of a control unit 60. The printheads 53 are located on an underside of the carriage 51 and selectively deposit a binding agent onto each layer of magnetic powder.

In this particular example, the magnets 55,57 comprise a first magnet 55 and a second magnet 57 carried by the carriage 51. The first magnet 55 is located on an underside of the carriage 51 adjacent a leading edge of the carriage 51. The second magnet 57 is located on the underside of the carriage 51 adjacent a trailing edge of the carriage 51. Each of the magnets 55,57 is an electromagnet having an on state and an off state. In other examples, the printer 10 may comprises a fewer or greater number of magnets, potentially located on other areas of the carriage 51.

The control unit 60 controls the movement of the carriage 51, the selective deposition of binding agent by the printheads 53, and the states of the magnets 55,57. In the example printer 10, the control unit 60 is provided in the base unit 20. However, the control unit 60 could equally be provided elsewhere, such as in the carriage assembly 50.

The 3D printer 10 further comprises containers 71,73 located in the base unit 20. In this particular example, the printer 10 comprises a first container 71 and a second container 73. The containers 71,73 are located such that, when the carriage 51 is in a home position (as shown in FIG. 1) the first container 71 is located below the first magnet 55, and the second container 73 is located beneath the second magnet 57. In this particular example, the printer 10 comprises a pair of containers 71,73, each located beneath a respective magnet 55,57. Alternatively, the printer 10 may comprise a single container located beneath both magnets 55,57.

As described above, during a build process, a layer of magnetic powder is deposited onto the build platform 21 and spread evenly by the spreader. The carriage 51 passes over the build platform 21, and the printheads 53 selectively deposit a binding agent to the layer of magnetic powder. The build platform 21 is lowered ready for the next layer of magnetic powder. This process is then repeated layer-by-layer until the build process is complete.

During the build process, some of the magnetic powder may aerosolized (i.e. thrown up into the print chamber 40) by the spreader and/or the carriage 51 as they move over the powder bed 23. The aerosolized magnetic powder then settles on surfaces within the print chamber 40.

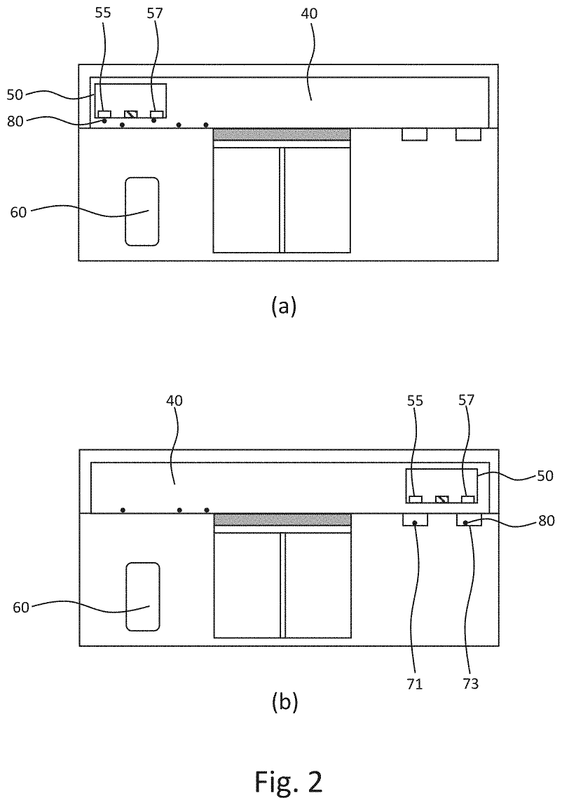

The control unit 60 includes a cleaning cycle, which may be performed at the end of a build process. To perform the cleaning cycle, the control unit 60 turns on the magnets 55,57 and instructs the drive assembly to drive the carriage 51 back and forth within the print chamber 40, as shown in FIG. 2. With the magnets 55,57 turned on, the magnets 55,57 collect residual magnetic powder 80 within the print chamber 40. The control unit 60 then instructs the drive assembly to drive the carriage 51 back to the home position (FIG. 2(b)) and turns off the magnets 55,57. As a result, the magnetic powder 80 collected by the magnets 55,57 falls and is deposited into the containers 71,73. This process may be repeated for each cleaning cycle.

In one example, the magnets 55,57 may deposit collected magnetic powder 80 into the containers 71,73 following every Nth pass of the carriage 51, where each pass corresponds to outward and return movement of the carriage 51 to the home position (FIG. 2(b)). Alternatively, the magnets 55,57 may deposit collected magnetic powder 80 when the magnets 55,57 are covered in powder 80. For example, the printer 10 may comprise a sensor (e.g. an optical sensor) to sense when the magnets 55,57 become saturated. The control unit 60 then returns the carriage 51 to the home position and turns off the magnets 55,57 when the control unit determines that the magnets 55,57 are saturated.

Following a cleaning cycle, the containers 71,73 may be emptied, for example, by removing the containers 71,73 to recover or dispose of the collected magnetic powder 80.

The first magnet 55 is adjacent the leading edge of the carriage 51 and the second magnet 57 is adjacent the trailing edge of the carriage 51. As a result, the magnets 55,57 may remove residual magnetic powder 80 from a greater area of the print chamber 40.

In the example described above, the magnets 55,57 are carried on the same carriage 51 as that which carries the printheads 53, conceivably the magnets 55,57 may be carried on a separate carriage, a robotic arm or the like. For example, the printer 10 may comprise a first carriage to carry the printheads 53, and a second carriage to carry the magnets 55,57.

It is intended that the cleaning cycle is performed at the end of a build process. However, conceivably, the cleaning cycle may be performed during a build process. In one example, the control unit 60 may turn off the magnets 55,57 when the carriage 51 is over the build platform 21, such that the magnets 55,57 do not disturb the powder bed 23. The control unit 60 may turn on the magnets 55,57 when the carriage 51 is moving away from the build platform 21. The magnets 55,57 are then turned off when the carriage is above the containers 71,73 to deposit the collected powder. Additional containers may then be provided on the opposite side of the print chamber 40 to the containers 71,73, such that collected powder may be deposited on both sides of the build platform 21. In a further example, the on state of each magnet 55,57 may comprise a high-power mode and a low-power mode. The control unit 60 may then operate the magnets 55,57 in the low-power mode during a build process, and the high-power mode at the end of a build process. In the low-power mode, the power supplied to the magnets 55,57 may be sufficiently low that the magnets 55,57 collect aerosolized magnetic powder from the print chamber 40 but do not collect residual magnetic powder 80 from the surfaces of the print chamber 40 and therefore do not disturb the powder bed 23.

Although the magnets 55,57 described above are electromagnets, it is conceivable that the magnets 55,57 may be permanent magnets. For example, as noted above, the magnets 55,57 may be carried on a second carriage which may be moved back and forth independently of the carriage 51 carrying the printheads 53. The cleaning cycle may therefore be performed at the end of the build process. Where permanent magnets are used, the printer 10 may comprise a scraper or the like to remove collected magnetic powder 80 from the magnets 55,57.

The example printer 10 described above is a 3D printer. Conceivably the principles described above, namely the use of magnets to collect residual magnetic powder within a print chamber, may be used with other types of printer for which magnetic powder may accumulate inside a print chamber.

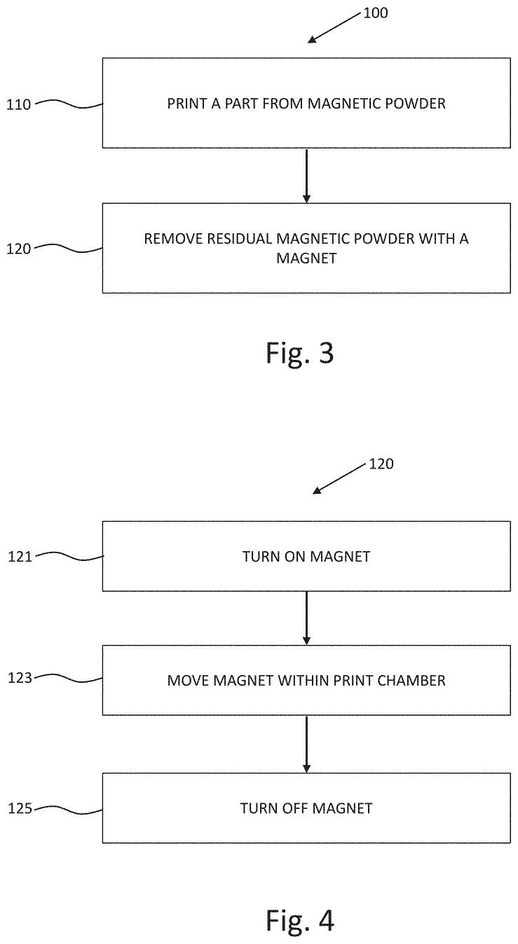

FIG. 3 shows an example method 100 for removing residual magnetic powder from a print chamber of a printer. The method 100 comprises printing 110, within a print chamber of a 3D printer, a part from magnetic powder. In one example, printing 110 may comprise printing a binding agent onto successive layers of a magnetic powder. The method further comprises removing 120 residual magnetic powder from the print chamber with a magnet. In one example, the residual magnetic powder may be removed after the part has been printed.

Turning to FIG. 4, the magnet may be an electromagnet and removing 120 residual magnetic powder from the print chamber may comprise turning on 121 the magnet to collect magnetic powder, moving 123 the magnet back and forth within the print chamber, and turning off 125 the magnet to release collected magnetic powder into a container. In one example, the magnet may be turned on when the magnet is away from a home position and turned off when the magnet is at the home position.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A printer comprising:
a print chamber; and
an electromagnet moveable within the print chamber,
wherein the electromagnet has an on state and an off state, the electromagnet is to collect magnetic powder within the print chamber when in the on state and is to deposit magnetic powder when in the off state.

2. A printer as claimed in claim 1, wherein the printer comprises a carriage, and the electromagnet is carried by the carriage.

3. A printer as claimed in claim 2, wherein the electromagnet is on an underside of the carriage.

4. A printer as claimed in claim 2, wherein the electromagnet is adjacent a leading edge of the carriage, and the printer comprises a further electromagnet adjacent a trailing edge of the carriage.

5. A printer as claimed in claim 1, wherein the printer comprises a control unit to turn on the electromagnet when the electromagnet is away from a home position and to turn off the electromagnet when the electromagnet is at the home position.

6. A printer as claimed in claim 1, wherein the printer comprises a build platform and a control unit to turn off the electromagnet when the electromagnet is over the build platform.

7. A printer as claimed in claim 1, wherein the printer is a 3D printer to form parts from magnetic powder.

8. A 3D printer comprising:
a print chamber;
a carriage moveable within the print chamber; and
a magnet carried by the carriage.

9. A 3D printer as claimed in claim 8, wherein the 3D printer comprises a build platform to receive magnetic powder, and a printhead to dispense binding agent onto the magnetic powder.

10. A 3D printer as claimed in claim 9, wherein the printhead is carried on the carriage.

11. A 3D printer as claimed in claim 8, wherein the magnet is carried on an underside of the carriage.

12. A method comprising:
printing, within a print chamber of a 3D printer, a part from magnetic powder; and
removing residual magnetic powder from the print chamber with a magnet.

13. A method as claimed in claim 12, wherein removing residual magnetic powder comprises moving the magnet back and forth within the print chamber.

14. A method as claimed in claim 12, wherein the magnet is an electromagnet and removing residual magnetic powder from the print chamber comprises turning on the magnet to collect residual magnetic powder, and turning off the magnet to release collected magnetic powder into a container.

15. A method as claimed in claim 14, wherein the magnet is turned on when the magnet is away from a home position and turned off when the magnet is at the home position.
